(19) United States
(12) Patent Application Publication
(10) Pub. No.: US 2011/0082227 A1
(43) Pub. Date: Apr. 7, 2011

(54) FOAMED POLYESTERS AND METHODS FOR THEIR PRODUCTION

(75) Inventors: Heinrich Rueger, Auw (CH); Michael Gisler, Cham (CH); Linus Villiger, Sins (CH); Cédric Muenger, Seon (CH)

(73) Assignee: 3A Technology & Managment Ltd, Neuhausen am Rheinfall (CH)

(21) Appl. No.: 12/996,648

(22) PCT Filed: Jun. 2, 2009
(86) PCT No.: PCT/EP2009/003911

§ 371 Date: Dec. 7, 2010

(30) Foreign Application Priority Data
Jun. 12, 2008 (CH) 0089208
Dec. 11, 2008 (CH) 0194308

(51) Int. Cl. C08G 63/00; C08G 63/46

(52) U.S. Cl. 521/182

(57) ABSTRACT

Foam bodies made of thermoplastic polyesters with high homogeneity, a low open-cell factor and high elongation at break under shear stress, the polyester foam containing at least one thermoplastic elastomer such as a thermoplastic copolyester elastomer, in quantities of, for example, 0.5 to 15% by weight based on the weight of the foam body. The foam bodies can be obtained by foaming a starting polyester with low intrinsic viscosity in a mixture with a modification means in the form of a premix containing dianhydrides of tetracarboxylic acids and thermoplastic copolyester elastomers.

The invention relates to foam bodies made of thermoplastic polyesters, with high homogeneity, a low open-cell factor and high elongation at break under shear stress, containing, as the modification means, dianhydrides of tetracarboxylic acids, means for producing the foam bodies and methods for producing foamed polyesters.

Foamed cellular polyesters and a method for their production are known, for example, from WO 93/12164. It is described that thermoplastic polyesters, which are suitable for extrusion foaming, for example, have an intrinsic viscosity of more than 0.8 dl/g. In order to obtain the disclosed value of the intrinsic viscosity, a two-stage method is described, according to which a polyester with an intrinsic viscosity of more than 0.52 dl/g has a dianhydride of an organic tetracarboxylic acid added and is made to react in order to obtain a polyester with an intrinsic viscosity of 0.85 to 1.95 dl/g. The foaming process can then be initiated by extrusion foaming with the polyester prepared in this way. In individual cases, further dianhydride of an organic tetracarboxylic acid can be added during the extrusion foaming.

The drawback of the method mentioned is that two laborious process steps are necessary to firstly mix the entire volume of polyester with the dianhydride of the tetracarboxylic acid and to then bring it to the reaction temperature in a solid phase reactor and to keep it at the temperature for several hours until the end of the reaction. The actual foaming process only then follows on from this.

According to U.S. Pat. No. 5,288,764, foamed polyester can be obtained by forming a molten mixture and extruding this mixture. The mixture is formed from a main fraction of polyester and a smaller part of a mixture of polyester with a substance which brings about a chain extension or branching.

The invention is based on the object of proposing foams made of polyester, means to produce them and a method to produce them in order, in a simple manner, to arrive at foams, or foam bodies, made of thermoplastic polyesters with advantageous properties. Particularly sought after foams made of polyester have, for example, in addition to a low density, a high homogeneity, a low open-cell factor, high strength and, in particular, a high elongation at break under shear stress. The foaming of polyesters into foam bodies is a process which can only be managed with difficulty. In particular polyesters with a low intrinsic viscosity (intrinsic viscosity, IV) can either not be foamed at all or, if foaming is nevertheless possible, the foams have poor properties such as varying high density, a high open-cell factor, irregular pore distribution and low elongation at break under shear stress.

The fact that the polyester foam of the foam body contains at least one thermoplastic elastomer, leads to the achievement of the object according to the invention.

For example, foam bodies which are made of polyesters according to the invention contain thermoplastic elastomers in quantities of 0.5 to 15.0% by weight, based on the weight of the foam body. Quantities of thermoplastic elastomers of 0.5 to 12% by weight and preferably from 1.5 to 12% by weight, in each case based on the weight of the foam body, are expedient.

The foam bodies which are made of polyesters according to the present invention, as the thermoplastic elastomers, advantageously contain polymer blends or thermoplastic copolyester elastomers.

Thermoplastic elastomers consist of or contain polymers or a polymer blend, which have properties at use temperature that are similar to those of vulcanised rubber but which may, however, be processed and prepared at elevated temperatures like a thermoplastic plastics material. The polymer blends have a polymer matrix made of hard thermoplastic with particles incorporated therein of soft cross-linked or uncross-linked elastomers. The thermoplastic copolyester elastomers contain hard thermoplastic sequences and soft elastomeric sequences. The thermoplastic copolyester elastomers contain polyester blocks, expediently made of a diol, preferably of 1,4-butanediol or 1,2-ethanediol, and a dicarboxylic acid, preferably terephthalic acid, which have been esterified with polyethers, which carry hydroxyl end groups, in a condensation reaction.

Thermoplastic elastomers (for example according to prEN ISO 18064) are also known by the abbreviation TPE and the subgroups by TPO (thermoplastic olefin elastomers), TPS (thermoplastic styrene elastomers), TPV (thermoplastic rubber vulcanisates), TPU (thermoplastic urethane elastomers), TPA (thermoplastic polyamide elastomers), TPC (thermoplastic copolyester elastomers) and TPZ (other, non-classified thermoplastic elastomers). Block polymers or segment polymers, such as, for example, thermoplastic styrene block polymers, thermoplastic copolyesters, polyether esters, thermoplastic polyurethanes or polyether-polyamide block copolymers belong to the TPEs. The TPEs receive their elastomeric properties either by copolymerisation of hard and soft blocks or by blending a thermoplastic matrix. In the case of graft copolymerisation, the hard segments form so-called domains, which act as physical cross-linking points. TPEs can be repeatedly melted and processed. The TPEs, described as thermoplastic copolyester elastomers, or also called TPCs, are divided into the TPC-EEs with soft segments with ether and ester bonds and the TPC-ES/-ETs with soft polyester segments, or polyether segments. The TPC-EEs are of particular interest here.

The thermoplastic copolyester elastomers, or thermoplastic copolyesters or thermoplastic polyether esters, or elastomeric copolyether esters are constructed alternately from hard polyester segments and soft polyether segments. Depending on the type and length of the hard and soft segments, a wide hardness range can be adjusted. Thermoplastic copolyesters are block copolymers consisting, on the one hand, of amorphous soft segments of polyalkylene ether diols and/or long-chain aliphatic dicarboxylic acid esters and, on the other hand, of hard segments of crystalline polybutylene terephthalate. The elastomeric copolyether esters are produced in the melt by re-esterification reactions between a terephthalate ester, a polyalkylene ether glycol (for example polytetramethylene ether glycol, polyethylene oxide glycol or polypropylene oxide glycol) and a short-chain diol, for example 1,4-butanediol or 1,2-ethanediol.

In order to increase the molecular weight in polyesters, a modification means can be added to the polyester. The modification means is, for example, a dianhydride of an organic tetracarboxylic acid (tetracarboxylic acid dianhydride). Preferred dianhydrides are the dianhydrides of the following tetracarboxylic acids:

Benzole-1,2,4,5-tetracarboxylic acid (pyromellitic acid),

3,3′,4,4′-diphenyltetracarboxylic acid,

3,3′,4,4′-benzophenone tetracarboxylic acid,

2,2-bis-(3,4-dicarboxyphenyl)-propane,

Bis-(3,4-dicarboxylphenyl)-ether,

Bis-(3,4-dicarboxylphenyl)-thioether,

Naphthalene-2,3,6,7-tetracarboxylic acid,

Bis-(3,4-dicarboxylphenyl)-sulphone,

Tetrahydrofurane-2,3,4,5-tetracarboxylic acid,

2,2-bis-(3,4-dicarboxlphenyl) hexafluoropropane,

1,2,5,6-naphthalene tetracarboxylic acid,

Bis-(3,4-dicarboxylphenyl)-sulphoxide and mixtures thereof.

The preferred dianhydride is pyromellitic acid dianhydride (benzole-1,2,4,5-tetracarboxylic acid-1,2:4,5-dianhydride).

Starting materials which can be used to produce foamed polyesters are polyesters such as thermoplastic polyesters, which can be obtained by polycondensation of aromatic dicarboxylic acids with diols. Examples of aromatic acids are terephthalic and isophthalic acids, naphthalene dicarboxylic acids and diphenyl ether dicarboxylic acids. Examples of diols are glycols such as ethylene glycol, tetraethylene glycol, cyclohexane dimethanol, 1,4-butanediol and 1,2-ethanediol.

Polyesters made of or containing polyethylene terephthalate, polybutylene terephthalate and polyethylene terephthalate copolymers containing up to 20% units of isophthalic acid are preferred.

A particularly important feature of the polyesters which are used as the starting material, which are modified according to the invention and foamed to form the foam bodies according to the invention, is the intrinsic viscosity. Until now it was not possible, starting from polyethers with an intrinsic viscosity of about 0.4 dl/g to produce foams. According to the present invention, foams with the required properties can already be reliably manufactured from starting materials, such as from polyesters with an intrinsic viscosity from values of about 0.4 dl/g and above and in particular from polyesters with an intrinsic viscosity of, for example, 0.6 to 0.7 dl/g and above. In order to increase low intrinsic viscosities, the proportion of the modification means, in particular the tetracarboxylic acid dianhydride, has to be correspondingly increased, based on the polyester used. The intrinsic viscosity of the processed polyester—and therefore its foamability—can easily be controlled by the selection of the concentration of the modification means in the premix and the quantity of the premix used with regard to the quantity of polyester. For example, the intrinsic viscosity of 0.6 to 0.7 dl/g can be increased by modification to above 1.0 or else 1.2 dl/g and thereabove.

The present invention also relates to means for producing foam bodies from polyesters with a high homogeneity, a low open-cell factor and high elongation at break under shear stress, containing dianhydrides of tetracarboxylic acids as the modification means. The means are a premix, containing thermoplastic elastomers, such as thermoplastic copolyester elastomers, in quantities of 25 to 95% by weight, based on the weight of the means, and dianhydrides of tetracarboxylic acids in quantities of 5 to 30% by weight, based on the weight of the means.

Means are preferred for producing foam bodies made of polyesters, in which the means is a premix, containing thermoplastic copolyester elastomers in quantities from 25 to 95% by weight and dianhydrides of a tetracarboxylic acid in quantities of 5 to 30% by weight and 0 to 70%, preferably 1 to 50% by weight, in each case based on the weight of the means, stabilisers, nucleation agents, flame protection means and/or polyesters, expediently a polyester of the same quality as a starting polyester which is to be modified.

The means, i.e. the premix, may be premanufactured and, in individual cases, immediately stored. The premix and the polyester which is to be foamed can then be mixed together in the provided quantities. This mixture of premix and polyesters can be further fed to the foaming process and processed into the foam bodies.

The present invention also relates to a method for producing foam bodies made of polyesters with a high homogeneity and elongation at break under shear stress, containing dianhydrides of a tetracarboxylic acid as the modification means.

According to the method of the invention for producing the foam bodies, a polyester resin has a premix of thermoplastic elastomers, such as thermoplastic copolyester elastomers, and dianhydrides of a tetracarboxylic acid added and is foamed to form a foam body, containing the thermoplastic copolyester elastomers in quantities of 0.5 to 15% by weight, based on the weight of the foam body.

The premix of thermoplastic elastomers, such as thermoplastic copolyester elastomers, and dianhydrides of a tetracarboxylic acid is produced as a precursor by mixing the components. The premix may contain 25 to 95% by weight, based on the premix, of copolyester elastomers and 5 to 30% by weight, based on the premix, of tetracarboxylic acid dianhydride. The premix expediently contains 50 to 90% by weight, advantageously 80 to 90% by weight, based on the premix, of copolyester elastomers and 10 to 25% by weight, advantageously 10 to 15% by weight, based on the premix, of tetracarboxylic acid dianhydride.

The premix may, as further constituents, for example contain a total of 0 to 70%, preferably 0.1 to 70% by weight and, in particular, 1 to 50% by weight, for example of polyesters, stabilisers, nucleation agents, fillers and flame protection means. The polyesters given with respect to the further components may be of the same quality as the polyesters to be modified, i.e. starting polyesters, for example with an intrinsic viscosity from about 0.4 dl/g and, in particular, polyesters with an intrinsic viscosity of about 0.6 to 0.7 dl/g and above.

The premix may be provided by feeding the components into a mixer, for example a screw extruder, such as a single-screw or twin-screw extruder or a multi-shaft extruder etc., and an intimate mixing of the components may take place over a time period of 10 to 120 seconds at temperatures of 200 to 260° C. The premix can be taken out of the mixer and brought into a further processable form, for example granulated.

The production of the foam bodies from polyesters takes place by means of a mixing and foaming process. For this purpose, for example, a polyester with an intrinsic viscosity of at least 0.4 dl/g is prepared and has the premix added. The premix may be used in quantities of 1.0 to 20.0% by weight, based on the polyester. Quantities of 2.0 to 4.0% by weight, based on the polyester, are advantageous.

In individual cases, in addition to the polyester and the premix, further components can be fed to the mixing and foaming process. These are the already mentioned stabilisers, fillers and flame protection means, which can instead be fed, if not already contained in the premix. The quantities of further components are, for example, up to 15% by weight, expediently 0.1 to 15% by weight, based on the sum of polyester and premix. Further components, for example to control the cell size and the cell distribution in the foam, can also be fed to the mixing and foaming process. For example, these are up to 5% by weight, expediently 0.1 to 5% by weight, (based on the sum of polyester and premix) of metal compounds of the first to third group in the periodic system, such as, for example, sodium carbonate, calcium carbonate, aluminium or magnesium stearate, aluminium or magnesium myrisate or sodium terephthalate and the further suitable compounds, such as, for example, talc or titanium dioxide.

The components can be fed to a reactor or mixer, for example a single-screw or twin-screw extruder or a multi-shaft extruder or a tandem system of two single-screw extruders combined with one another, or of a twin-screw and a single-screw extruder combined with one another. The residence time of the components in the reactor or mixer may be, for example, from 8 to 40 minutes. The temperature during the residence time may be from 240 to 320° C.

The blowing agent for foaming is also fed to the reactor or mixer, for example the extruders mentioned. Suitable blowing agents are, for example, easily vaporisable liquids, thermally decomposing materials which release gases or inert gases as well as mixtures or combinations of said means. Saturated aliphatic or cycloaliphatic hydrocarbons, aromatic hydrocarbons and halogenated hydrocarbons are included in the easily vaporisable liquids. Examples are butane, pentane, hexane, cyclohexane, ethanol, acetone and HFC 152a. CO₂ and nitrogen can be mentioned as the inert gas. The blowing agent is generally fed after the feed region of the components into the extruder.

At the shaping outlet opening of the extruder, the foam body is continuously produced from as far as possible substantially closed-cell foam, which may, for example, have a round, rounded, rectangular or polygonal cross-section. The foam body can then be conveyed, according to the use, formed, cut and/or joined. If foam bodies are produced, the foam bodies can be stacked next to one another and/or on top of one another and processed to form foam blocks, in particular homogeneous foam blocks with mutual non-separable connection, such as mutual adhesion or in particular welding. The foam bodies may be sheet-like and stacked. The surfaces which touch one another may be connected to one another over the whole area, such as welded. As a result, foam blocks are produced with weld seams, which run in the extrusion direction. Individual foam sheets may be separated from the foam block, in particular transverse to the extrusion direction or transverse to the weld seams.

The foam body according to the invention has the following features in particular:
purity of type, only polyesters and no further different types of polymers are present.
regular closed-cell pores.

The foam bodies according to the invention, with a bulk density of about 120 kg/m³, in particular have the following advantageous features:
shear strength under shear stress to ISO 1922, for example greater than 1.0 N/mm²,
shear modulus (G-modulus) to ASTM C393, for example greater than 20 N/mm².
elongation at break under shear stress to ISO 1922, for example with values of more than 12%, expediently more than 16% and preferably more than 50%.
compressive strength to ISO 844, for example greater than 1.7 N/mm² compressive modulus (E-modulus) to DIN 53421, for example greater than 90 N/mm².
open-pore factor according to the Airex method AM-19 based on ASTM D1056-07, for example of less than 8% and in particular less than 4%. The open-cell factor measurement according to the Airex method AM-19 is carried out as described in ASTM D 1056, but calculated with a different formula: ASTM D 1059: W =[(A-B)/B]×100 with W=change in mass [%]; A=final mass of specimen; and B =initial mass of specimen.
   Airex AM-19: OZ =[(A-B)/(L×B×D)] x 100 with OZ =open-cell factor [Vol-%] A=weight of the sample after conditioning [g]; B=weight of the sample before conditioning [g]; L, B, D=length, width, thickness of the sample [cm]; the density of the water at 1 g/cm³ is not explicitly shown in the formula. According to the present invention, for example, values in the water adsorption test of below 40% by weight are achieved, expediently of below 35% by weight and, in particular, of below 30% by weight.
the viscosity number of the resulting foam is determined to ISO 1628/5 and may, for example, be more than 150 ml/g, approximately in accordance with an intrinsic viscosity of more than 1.2 dl/g. A viscosity number of the resulting foam, determined to ISO 1628/5, of for example more than 160 ml/g, for example, in accordance with an intrinsic viscosity of more than 1.30 dl/g, is preferred.

The method according to the invention is also distinguished, for example, in that no gel formation takes place during extrusion. The premix can be completely mixed with the polyester and no undesired second phase is formed. The premix can be produced on devices which are known per se, so-called compounding devices, the process being easy to manage. The properties of the foam body being produced can also easily be controlled by the selection of the thermoplastic copolyester elastomers (TPCs) and the soft elastomers contained therein and hard thermoplastic sequences.

### EXAMPLES

### Premix Example 1

Thermoplastic copolyester elastomer (TPC) in the form of granulate with a Shore hardness of 55 D is dried for 4 hours at 100° C. by means of hot air. On a twin-screw extruder, rotating in the same directions, with a 27 mm cylinder diameter and an L/D ratio of 40, 85% by weight TPC and 15% by weight pyromellitic acid dianhydride (PMDA) are mixed at a cylinder temperature between 200 and 210° C. and at a speed of 200 rpm under a protective gas atmosphere and discharged in strand form. The strands, after cooling in the water bath and drying with an air blower in a granulating device are converted by means of a rotating blade into a cylindrical granulate. The premix thus obtained is finally dried for 3 hours at 70° C.

### Premix Example 2

Thermoplastic copolyester elastomer (TPC) in the form of granulate with a Shore hardness of 33 D is dried for 4 hours at 100° C. by means of hot air. On a twin-screw extruder, rotating in the same directions, with a 27 mm cylinder diameter and an L/D ratio of 40, 85% by weight TPC and 15% by weight pyromellitic acid dianhydride (PMDA) are mixed at a cylinder temperature between 200 and 210° C. and at a speed of 200 rpm under a protective gas atmosphere and discharged in strand form. The strands, after cooling in the water bath and drying with an air blower in a granulating device are converted by means of a rotating blade into a cylindrical granulate. The premix thus obtained is finally dried for 3 hours at 70° C.

### Premix Comparative Example

Polyester granulate (PET) with an intrinsic viscosity of 0.81 dl/g is dried by means of hot air at 150° C. for 8 hours. On the same system as in Example 1, 85% by weight PET granulate and 15% by weight pyromellitic acid dianhydride (PMDA) are mixed at a cylinder temperature between 240 and 250° C. and at a speed of 200 rpm under a protective gas atmosphere and discharged in strand form. The strands, after cooling in a water bath and drying with an air blower in a granulating device are converted by means of a rotating blade into a cylindrical granulate. The premix thus obtained is finally dried for 3 hours at 70° C.

TABLE 1
Test parameters for producing the premixes

| | | Example | Example | Comparative |
|---|---|---|---|---|
| Premix | | 1 | 2 | example |
| Formulation | | | | |
| TPC fraction | % by weight | 85.0 | 85.0 | |
| PET fraction | % by weight | | | 85.0 |
| PMDA fraction | % by weight | 15.0 | 15.0 | 15.0 |
| Machine parameters | | | | |
| Temperature feed zone | ° C. | 200 | 200 | 250 |
| Temperature mixing zone | ° C. | 210 | 210 | 250 |
| Temperature discharge | ° C. | 205 | 205 | 240 |
| zone | ° C. | 199 | 204 | 238 |
| Mass temperature | Bar | 34 | 12 | 12 |
| Mass pressure | % | 52 | 33 | 43 |
| Armature current extruder | kg/h | 20 | 20 | 20 |
| Throughput | rpm | 200 | 200 | 200 |
| Speed of extruder | m/min | 30 | 30 | 30 |
| Draw-off speed | | | | |
| Premix | | | | |
| Bulk density | g/dl | 65.4 | 59.7 | 76.5 |

### Foaming Example 1

96.3% by weight PET granulate as the starting material with an intrinsic viscosity of 0.81 dl/g are dried for about 5 hours at 170° C. with dry air and together with 2.7% by weight of the premix from Example 1 (dried for about 11 hours with dry air at 60° C.) and 1.0% of a nucleation agent (30% talc in PET; dried for about 11 hours with dry air at 60° C.) are metered into the first extruder of an extrusion foaming system with two screw extruders, melted, mixed and foamed with CO₂. The melt temperature at the outlet of the extrusion tool is 248° C., the throughput about 290 kg/h, the residence time in the extruder about 17 min. Foam bodies are continuously produced, for example with an approximately cuboid cross-section, which are cut to length to sheet-like foam bodies. The sheet-like foam bodies are stacked and welded to one another at the contact faces, foam blocks being produced. The measured values given in the examples are determined on foam sheets, which are separated off from the foam blocks transverse to the extrusion direction. The viscosity number of the resulting foam is determined to ISO 1628/5 and is 164.0 ml/g, corresponding to an intrinsic viscosity of 1.32 dl/g.

### Foaming Example 2

96.3% by weight PET granulate with an intrinsic viscosity of 0.81 dl/g are dried for about 5 hours at 170° C. with dry air and together with 2.7% by weight of the premix from Example 2 (dried for about 11 hours with dry air at 60° C.) and 1.0% of a nucleation agent (30% talc in PET; dried for about 11 hours with dry air at 60° C.) are metered into the first extruder of an extrusion foaming system with two screw extruders, melted, mixed and foamed with CO₂. The melt temperature at the outlet of the extrusion tool is 249° C., the throughput is about 290 kg/h, the residence time in the extruder is about 17 min. The viscosity number of the resulting foam is determined to ISO 1628/5 and is 165.6 ml/g, which corresponds to an intrinsic viscosity of 1.33 dl/g.

### Foaming Example 3

86.7% by weight PET granulate with an intrinsic viscosity of 0.81 dl/g are dried for about 5 hours at 170° C. with dry air and together with 2.3% by weight of the premix from Example 2 (dried for about 11 hours with dry air at 60° C.) and 1.0% of a nucleation agent (30% talc in PET; dried for about 11 hours with dry air at 60° C.) and 10% by weight of a thermoplastic copolyester elastomer (TPC) with a Shore hardness of 33 D (dried for about 12 hours with dry air at 100° C.) are metered into the first extruder or an extrusion foaming system with two screw extruders, melted, mixed and foamed with CO₂. The melt temperature at the outlet from the extrusion tool is 248° C., the throughput is about 270 kg/h, the residence time in the extruder is about 18 min. The viscosity number of the resulting foam is determined to ISO 1628/5 and is 162.2 ml/g, which corresponds to an intrinsic viscosity of 1.30 dl/g.

### Foaming, Comparative Example

96.3% by weight PET granulate with an intrinsic viscosity of 0.81 dl/g are dried for about 5 hours at 170° C. with dry air and together with 2.7% by weight of the premix from the comparative example (dried for about 11 hours with dry air at 60° C.) and 1.0% of a nucleation agent (30% talc in PET; dried for about 11 hours with dry air at 60° C.) are metered into the first extruder of an extrusion foaming system with two screw extruders, melted, mixed and foamed with CO₂. The melt temperature at the outlet of the extrusion tool is 247° C. The throughput has to be reduced to 200 kg/h, in order to realise the required open-cell factor value of <8%. The residence time in the extruder is thereby increased to about 24 min. The viscosity number of the resulting foam to ISO 1628/5, despite the longer residence time, at 157.8 ml/g is lower than in Examples 1 and 2 as is therefore also the correlating intrinsic viscosity (1.27 dl/g).

The mechanical properties of the foams obtained are listed in Table 2.

TABLE 2
Mechanical properties of the foams obtained

| | | | | | | Comparison |
|---|---|---|---|---|---|---|
| Foaming | | | Example 1 | Example 2 | Example 3 | example |
| Bulk density | kg/m² | ISO 845 | 121.3 | 120.5 | 122.2 | 121.8 |
| Compressive | N/mm² | ISO 844 | 1.79 | 1.75 | 1.59 | 1.81 |
| strength | | | | | | |
| E-modulus | N/mm² | DIN 53421 | 102.4 | 97.2 | 97.6 | 106.9 |
| (compressive | | | | | | |
| modulus) | | | | | | |
| vertical | | | | | | |
| Shear | N/mm² | ISO 1922 | 1.11 | 1.08 | 1.32 | 1.07 |
| strength | | | | | | |
| G-modulus | N/mm² | ASTM | 23.6 | 22.4 | 19.8 | 23.8 |
| (shear | | C393 | | | | |
| modulus) | | | | | | |
| Elongation at | % | ISO 1922 | 16.0 | 15.8 | 73.3 | 8.0 |
| break under | | | | | | |
| shear stress | | | | | | |
| Open-cell | Vol % | AM-019 | 3.0 | 3.4 | 3.2 | 5.2 |
| factor | | | | | | |
| Water | % by | ASTM | 27.2 | 29.9 | 28.9 | 45.1 |
| absorption | weight | D1056 | | | | |
| Test | | | | | | |

1. A foam body made of thermoplastic polyesters, with high homogeneity, a low open-cell factor and high elongation at break under shear stress, containing one or more dianhydrides of tetracarboxylic acids as the modification means, wherein the polyester foam contains one or more thermoplastic elastomers.

2. A foam body made of polyesters according to claim 1, wherein the thermoplastic elastomers are contained in quantities of 0.5 to 15% by weight, based on the weight of the foam body.

3. A foam body made of polyesters according to claim 1 wherein one or more thermoplastic copolyester elastomers are contained in the polyester foam as thermoplastic elastomers.

4. A foam body made of polyesters according to claim 3, wherein the thermoplastic copolyester elastomers are contained in quantities of 0.5 to 15% by weight, based on the weight of the foam body.

5. A foam body made of polyesters according to claim 3 wherein the thermoplastic copolyester elastomers contain polyester blocks, the polyester blocks being made of a diol and a dicarboxylic acid, which are esterified with polyethers carrying hydroxyl end groups in a condensation reaction.

6. A foam body made of polyesters according to claim 1 wherein the polyester foam body has an open-cell factor of less than 8%.

7. A foam body made of polyesters according to claim 1 wherein the foam body has an elongation at break under shear stress of more than 12%.

8. A method for producing a foam body from one or more thermoplastic polyesters, with high homogeneity, a low open-cell factor and high elongation at break under shear stress, containing one or more dianhydrides of tetracarboxylic acids as the modification means, comprising mixing and foaming at least one polyester and a premix of one or more thermoplastic elastomers, and one or more dianhydrides of tetracarboxylic acids, to form a foam body, containing the thermoplastic elastomers in quantities from 0.5 to 15% by weight, based on the weight of the foam body.

9. A method for producing a foam body from polyesters according to claim 8, wherein the polyester with the premix of thermoplastic copolyester elastomers and dianhydrides of tetracarboxylic acids is fed as a component to a reactor or mixer, and is mixed there.

10. A method for producing a foam body from one or more polyesters, with high homogeneity, a low open-cell factor and high elongation at break under shear stress, containing one or more dianhydrides of tetracarboxylic acids as the modification means, comprising using a premix containing one or more thermoplastic elastomers, in quantities of 25 to 95% by weight, based on the weight of the premix, and one or more dianhydrides of tetracarboxylic acids in quantities of 5 to 30% by weight, based on the weight of the premix.

11. A method for producing a foam body from polyesters according to claim 10, wherein the premix contains one or more thermoplastic copolyester elastomers in quantities from 50 to 90% by weight and one or more dianhydrides of tetracarboxylic acids in quantities from 10 to 25% by weight, based on the weight of the premix.

12. A method for producing a foam body from polyesters according to claim 10, wherein the premix, contains 1 to 50% by weight, in each case based on the weight of the premix, of one or more stabilisers, nucleation agents, flame protection agents or polyesters.

13. A foam body made of polyesters according to claim 5, wherein the diol is 1,4-butanediol or 1,2-ethanediol.

14. A foam body made of polyesters according to claim 5, wherein the dicarboxylic acid is terephthalic acid.

15. A foam body made of polyesters according to claim 5, wherein the diol is 1,4-butanediol or 1,2-ethanediol and the dicarboxylic acid is terephthalic acid.

16. A foam body made of polyesters according to claim 1, wherein the foam body has an open-cell factor of less than 4%.

17. A foam body made of polyesters according to claim 1 wherein the polyester foam has an elongation at break under shear stress of more than 50%.

18. A foam body made of polyesters according to claim 9 wherein the reactor or mixer is selected from the group consisting of single-screw extruders, twin-screw extruders, multi-shaft extruders, tandem systems of two single-screw extruders combined with one another, and tandem systems of a twin-screw extruder and a single screw extruder.

19. A method for producing a foam body from polyesters according to claim 10, wherein the premix contains one or more thermoplastic copolyester elastomers in quantities from 80 to 90% by weight and dianhydrides of tetracarboxylic acids in quantities from 10 to 15% by weight, based on the weight of the premix.

20. A method for producing a foam body from polyesters according to claim 8, wherein the premix and a polyester having an intrinsic viscosity of at least about 0.4 dl/g selected from the group consisting of polyethylene terephthalate, polybutylene terephthalate and polyethylene terephthalates containing up to 20% units of isophthalic acid are melted, mixed and foamed with carbon dioxide.
